(19) United States
(12) Patent Application Publication
(10) Pub. No.: US 2014/0253497 A1
(43) Pub. Date: Sep. 11, 2014

(54) CAPACITIVE TOUCH DEVICE

(71) Applicant: PixArt Imaging Inc., Hsin-Chu County (TW)

(72) Inventors: FU-CHEN CHEN, HSIN-CHU COUNTY (TW); MING-TSAN KAO, HSIN-CHU COUNTY (TW); YU-HAN CHEN, HSIN-CHU COUNTY (TW)

(73) Assignee: PIXART IMAGING INC., Hsin-Chu County (TW)

(21) Appl. No.: 14/161,827

(22) Filed: Jan. 23, 2014

(30) Foreign Application Priority Data
Mar. 6, 2013 (TW) 102107772

(51) Int. Cl. G06F 3/041; G06F 3/044

(52) U.S. Cl. CPC G06F 3/0416; G06F 3/044
USPC 345/174

(57) ABSTRACT

There is provided a capacitive touch device including a controlling and processing circuit and a touch panel. The touch panel has a plurality of detection cells arranged in matrix. The controlling and processing circuit is configured to input a drive signal to the detection cells of the touch panel and read measurement data from the detection cells for post-processing, wherein the controlling and processing circuit reads a first sampling number of the measurement data of the detection cells in a normal mode and a second sampling number of the measurement data of the detection cells in a sleep mode, and the second sampling number is lower than the first sampling number.

### CROSS REFERENCE TO RELATED APPLICATION

This application claims the priority benefit of Taiwan Patent Application Serial Number 102107772, filed on Mar. 6, 2013, the full disclosure of which is incorporated herein by reference.

### BACKGROUND

1. Field of the Disclosure

This disclosure generally relates to an input device and, more particularly, to a capacitive touch device capable of reducing the power consumption and increasing the report rate.

2. Description of the Related Art

As the touch panel can be operated easily and needs not to be operated in cooperation with additional peripheral devices such as the mouse device or keyboard, it has been widely applied to various portable electronic devices and home appliances. In the capacitive touch panel, the active area on which the user operates is generally only a part of the touch panel. In consideration of the power efficiency, preferably the power consumption can be reduced not only in a sleep mode but also in a normal mode.

Conventionally, in the sleep mode the power consumption can be reduced by reducing the scanning frequency. For example, U.S. Patent Publication No. US20090251427 A1 discloses a power saving method in which a scanning cycle of 4 ms is used in the normal mode and a scanning cycle of 40 ms is used in the sleep mode, and this method confirms whether to switch from the normal mode to the sleep mode by identifying whether a touch event occurs in a long time interval. However in the sleep mode, the reduced scanning frequency causes the report rate to be decreased at the same time such that the time for detecting the occurrence of a first contact may be delayed thereby reducing the response time of the touch panel.

Accordingly, the present disclosure further provides a capacitive touch device that may reduce the total power consumption of the touch panel in both the sleep mode and normal mode, and the occurrence of a first contact can be detected real-timely.

### SUMMARY

The present disclosure provides a capacitive touch device that may scan only a part of the touch panel and/or reduce a sampling number of the measurement data of the touch panel in a sleep mode thereby reducing the total power consumption.

The present disclosure provides a capacitive touch device that may scan only a part of the touch panel and/or reduce a sampling number of the measurement data of a partial region of the touch panel in a normal mode thereby reducing the total power consumption.

The present disclosure provides a capacitive touch device that may reduce a sampling number of the measurement data of the touch panel thereby increasing the report rate and the detecting reactivity.

The present disclosure provides a capacitive touch device including a touch panel and a controlling and processing circuit. The touch panel includes a plurality of detection cells arranged in matrix. The controlling and processing circuit is configured to input a drive signal to the detection cells of the touch panel and read measurement data from the detection cells, wherein the controlling and processing circuit reads a first sampling number of the measurement data of the detection cells in a normal mode and a second sampling number of the measurement data of the detection cells in a sleep mode; and the second sampling number is lower than the first sampling number.

The present disclosure further provides a capacitive touch device including a touch panel and a controlling and processing circuit. The touch panel includes a plurality of detection cells arranged in matrix. The controlling and processing circuit is configured to input a drive signal to the detection cells of the touch panel and read measurement data from the detection cells, wherein the controlling and processing circuit reads, within a first frame interval, a first sampling number of the measurement data of the detection cells in a normal mode and reads, within a second frame interval, a second sampling number of the measurement data of the detection cells in a sleep mode; and the second sampling number is lower than the first sampling number and the second frame interval is shorter than the first frame interval.

The present disclosure further provides a capacitive touch device including a touch panel and a controlling and processing circuit. The touch panel includes a plurality of detection cells arranged in matrix. The controlling and processing circuit is configured to input a drive signal to the detection cells of the touch panel and read measurement data from the detection cells, wherein the controlling and processing circuit reads the measurement data of only a part of the detection cells in a sleep mode.

In one aspect, the controlling and processing circuit reads a plurality of data points of every detection cell at the same sampling frequency. For example, sampling frequencies of reading the first sampling number and the second sampling number are identical.

In one aspect, in the normal mode the controlling and processing circuit may select to read a higher sampling number (e.g. the first sampling number) of the measurement data of all or a part of the detection cells, wherein when the controlling and processing circuit reads the first sampling number of the measurement data of only a part of the detection cells, the controlling and processing circuit reads a lower sampling number (e.g. the second sampling number) of the measurement data of other parts of the detection cells so as to further reduce the power consumption.

In one aspect, frame intervals that the controlling and processing circuit scans the touch panel may or may not include an idle interval. If the frame intervals include the idle interval, the power consumption is reduced whereas if the frame intervals do not include the idle interval, the scanning frequency and the report rate are further increased.

In one aspect, when the controlling and processing circuit reads the measurement data of only a part of the detection cells in the normal mode and the sleep mode, the controlling and processing circuit preferably reads the measurement data of different parts of the detection cells respectively within adjacent frame intervals such that all detection cells can be detected at least once in at least two frame intervals.

In the capacitive touch device according to the embodiment of the present disclosure, in the sleep mode it is able to read a lower sampling number of the measurement data of a part or all of the detection cells so as to reduce the power consumption and increase the detecting reactivity. In the normal mode it is able to read a normal sampling number of the measurement data of all detection cells in a peripheral range of the detection cells around a touch point and read a lower sampling number of the measurement data of a part or all of the detection cells outside the peripheral range thereby reducing the power consumption and increasing the detecting reactivity.

### BRIEF DESCRIPTION OF THE DRAWINGS

Other objects, advantages, and novel features of the present disclosure will become more apparent from the following detailed description when taken in conjunction with the accompanying drawings.

FIG. 1 shows a schematic block diagram of the capacitive touch device according to an embodiment of the present disclosure.

FIG. 2 shows a schematic diagram of the capacitive touch device according to an embodiment of the present disclosure.

FIG. 3A shows a schematic diagram of reading the measurement data of a part of detection cells in a sleep mode of the capacitive touch device according to the embodiment of the present disclosure.

FIG. 3B shows another schematic diagram of reading the measurement data of a part of detection cells in a sleep mode of the capacitive touch device according to the embodiment of the present disclosure.

FIG. 4 shows a schematic diagram of reading the measurement data of a part of detection cells in a normal mode of the capacitive touch device according to the embodiment of the present disclosure.

FIG. 5 shows an operational schematic diagram of the capacitive touch device according to a first embodiment of the present disclosure.

FIG. 6 shows an operational schematic diagram of the capacitive touch device according to a second embodiment of the present disclosure.

FIG. 7 shows a schematic diagram of reading the measurement data of detection cells of the capacitive touch device according to the embodiment of the present disclosure.

### DETAILED DESCRIPTION OF THE EMBODIMENT

It should be noted that, wherever possible, the same reference numbers will be used throughout the drawings to refer to the same or like parts.

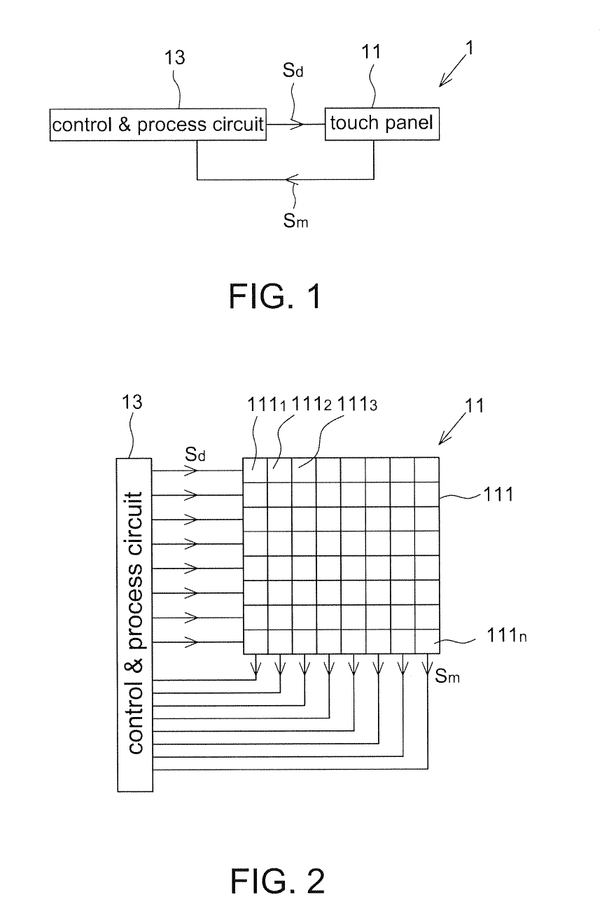

Referring to FIGS. 1 and 2, FIG. 1 shows a schematic block diagram of the capacitive touch device according to an embodiment of the present disclosure and FIG. 2 shows a schematic diagram of the capacitive touch device according to an embodiment of the present disclosure. The capacitive touch device 1 according to the present disclosure includes a touch panel 11 and a controlling and processing circuit 13. In this embodiment, the touch panel 11 may be a capacitive touch panel and includes a plurality of detection cells 111 (e.g. including 111₁-111ₙ) arranged in matrix as shown in FIG. 2 on which a user performs the touch operation. The controlling and processing circuit 13 is coupled to the touch panel 11 and configured to output a drive signal Sd to the detection cells 111 of the touch panel 11 and to sequentially read measurement data Sm from the detection cells 111 and further to identify at least one touch point according to the read measurement data Sm and output a corresponding control signal to a user graphic interface, wherein the connection between the controlling and processing circuit 13 and the touch panel 11 is well known, e.g. inputting the drive signal Sd and sequentially reading the measurement data Sm via a plurality of switching devices, and thus details thereof are not described herein. The drive signal Sd may be a continuous voltage signal, e.g. the sinusoidal wave, square wave or other symmetric or asymmetric voltage signals. The controlling and processing circuit 13 respectively reads a predetermined sampling number of the measurement data Sm of every detection cell 111 for calculating the touch information, e.g. reading 128, 64 or 32 data points of the measurement data Sm of every detection cell 111 at a sampling frequency for identifying the touch information, such as a touch event and a touch position. It is appreciated that the sampling number sampled by the controlling and processing circuit 13 for calculating the touch information may be determined according to the accuracy required and is not limited to that disclosed in the present disclosure. The touch information is configured to correspondingly control an electronic device to execute specific applications, and as it is well known to the art, details thereof are not described herein.

In the present disclosure, the capacitive touch device 1 may be operated in a normal mode and a sleep mode (described exemplary below), wherein the normal mode may include two implementations. The controlling and processing circuit 13 preferably inputs identical drive signals into every detection cell 111 in different modes. The normal mode is referred to an operation mode that the controlling and processing circuit 13 identifies that at least one pointer, e.g. a finger is operating on the touch panel 11; and the sleep mode is referred to an operation mode that the controlling and processing circuit 13 identifies that there is no pointer operating on the touch panel 11 for a predetermined time interval.

A partial sleep mode is another aspect of the normal mode. For example, when the controlling and processing circuit 13 identifies that at least one pointer is operating on the touch panel 11, the detection cells 111₁-111ₙ of the touch panel 11 is divided into a first region and a second region, wherein the first region may be a predetermined range around at least one touch point (including the detection cell associated the touch point) and the second region may be other detection cells 111 outside the first region. The capacitive touch device 1 performs the similar operation as the normal mode in the first region of the detection cells 111 but performs the similar operation as the sleep mode in the second region of the detection cells 111. It should be mentioned that in the present disclosure the partial sleep mode may not be implemented; i.e. in the normal mode the detection cells 11 may not be further divided in to different regions.

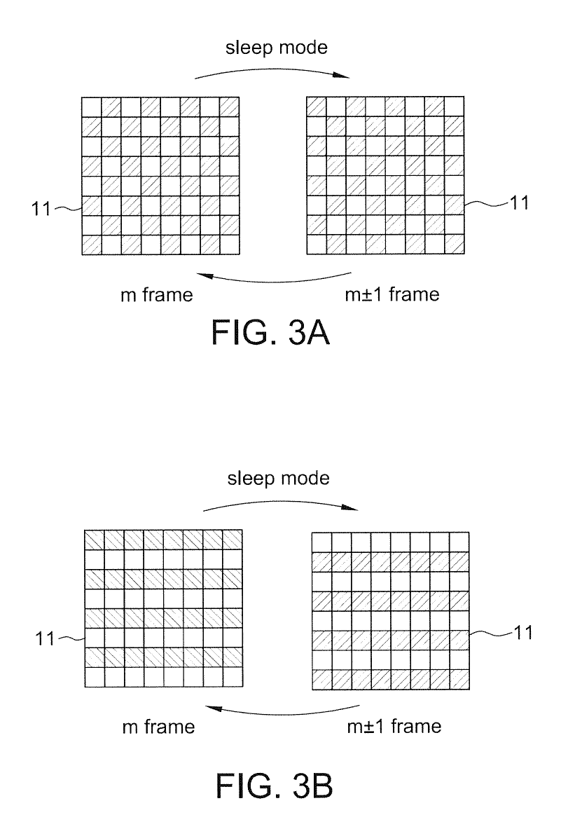

Referring to FIGS. 3A and 3B, they show schematic diagrams of reading, in a sleep mode, the measurement data of a part of the detection cells of the capacitive touch device 1 according to the embodiment of the present disclosure. As mentioned above, when the controlling and processing circuit 13 identifies that there is no finger in contact with the touch panel 11 within a predetermined time interval, a sleep mode is entered so as to reduce the power consumption. In the sleep mode, the controlling and processing circuit 13 inputs a drive signal Sd to all or a part of the detection cells 111 of the touch panel 11 and reads the measurement data Sm of only a part of the detection cells 111. When identifying that at least one of the detection cells 111 detects a touch event, the controlling and processing circuit 13 controls the capacitive touch device 1 to return to a normal mode.

FIGS. 3A and 3B show that the controlling and processing circuit 13 respectively reads the measurement data of different parts of the detection cells 111 within adjacent frame intervals, e.g. different detection cells 111 are read within the mth frame interval and the (m±1)th frame intervals. In this manner, when a touch event occurs only at a single detection cell 111, it is able to prevent the sleep mode from not being ended. For example, FIG. 3A shows that the part of the detection cells 111 read by the controlling and processing circuit 13 is a chessboard pattern; and FIG. 3B shows that the part of the detection cells 111 read by the controlling and processing circuit 13 is non-adjacent rows of the detection cells 111. It should be mentioned that as long as all detection cells 111 can be read within at least two adjacent frame intervals, the distribution of the part of the detection cells 111 that are read by the controlling and processing circuit 13 in each frame interval is not limited to those shown in FIGS. 3A and 3B, e.g. the part of the detection cells 111 read by the controlling and processing circuit 13 may be non-adjacent columns of the detection cells 111. In the present disclosure, the frame interval is referred to a time interval in which the controlling and processing circuit 13 scans all or a part of the detection cells 22 and reports once.

In the present disclosure, the controlling and processing circuit 13 may further read identical or different sampling numbers of the measurement data of the detection cells 111 in the normal mode or the sleep mode.

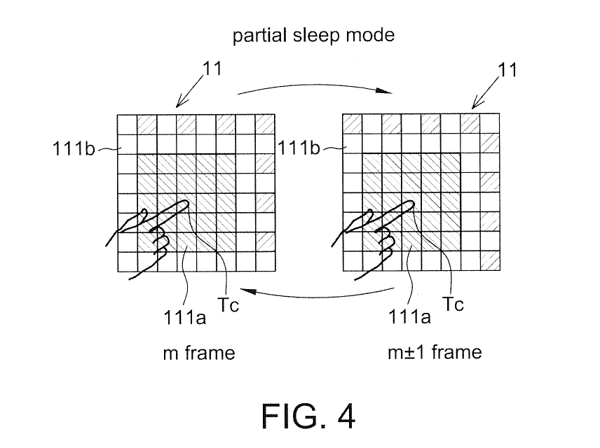

In one embodiment, in the normal mode the controlling and processing circuit 13 may read the measurement data of all of the detection cells 111, and report a touch event or a touch coordinate once every frame interval. Referring to FIG. 4, it shows a schematic diagram of a normal mode of the capacitive touch device 1 according to the embodiment of the present disclosure; in another embodiment, in the normal mode the controlling and processing circuit 13 may read the measurement data of all detection cells in a first region 111a of the detection cells 111 and read the measurement data of a part of detection cells in a second region 111b of the detection cells 111, wherein the first region 111a may be a predetermined range around a touch point Tc and the second region 111b may be all or a part of the detection cells 111 of the touch panel 11 outside the first region 111a. Accordingly, as the controlling and processing circuit 13 may read the measurement data of only a part of the detection cells 111 outside the first region 111a, the power consumption is reduced in the normal mode, i.e. the partial sleep mode.

As mentioned above, in the present disclosure the controlling and processing circuit 13 may read the measurement data of only a part of the detection cells 111 in the sleep mode or the partial sleep mode so as to reduce the power consumption.

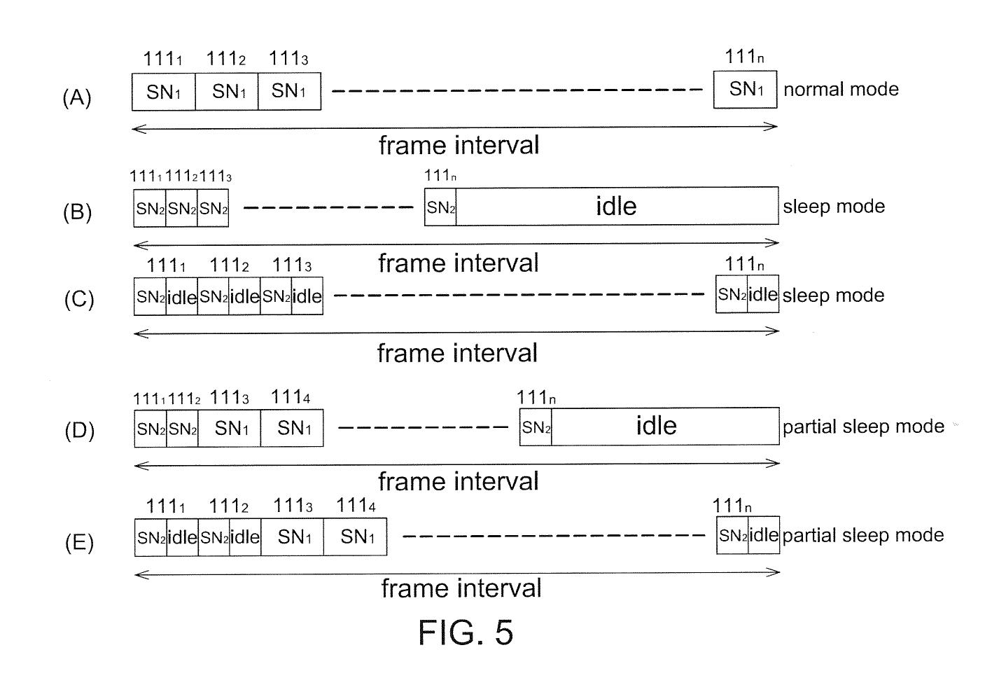

Referring to FIG. 5, it shows an operational schematic diagram of the capacitive touch device according to a first embodiment of the present disclosure. In this embodiment, in a normal mode the controlling and processing circuit 13 reads a first sampling number SN₁ of the measurement data of the detection cells 111₁-111ₙ; and in a sleep mode the controlling and processing circuit 13 reads a second sampling number SN₂ of the measurement data of the detection cells 111₁-111ₙ so as to reduce the power consumption in the sleep mode, wherein the second sampling number SN₂ is lower than the first sampling number SN₁. In this embodiment, the controlling and processing circuit 13 reads a plurality of data points of every detection cell 111 always at the same sampling frequency.

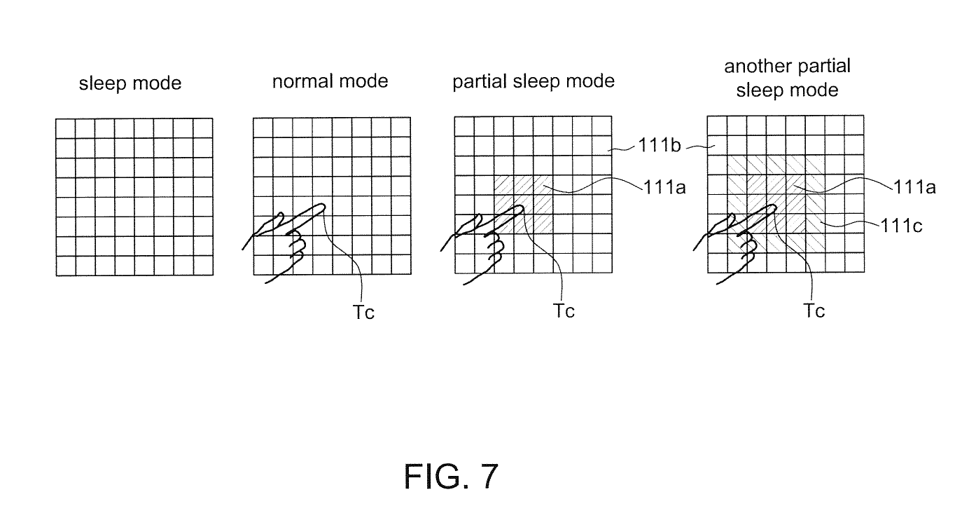

FIG. 5(A) shows the operational schematic diagram of the normal mode. When the controlling and processing circuit 13 identifies that at least one finger is in contact with the touch panel 11 (as the normal mode shown in FIG. 7), the controlling and processing circuit 13 reads a first sampling number SN₁ of the measurement data of each of the detection cells 111₁-111ₙ at the sampling frequency, wherein the first sampling number SN₁ may be 128, but not limited to. In one frame interval, the controlling and processing circuit 13 scans all of the detection cells 111 and reports the touch information.

FIGS. 5(B) and 5(C) show the operational schematic diagrams of the sleep mode. When the controlling and processing circuit 13 identifies that there is no finger in contact with the touch panel 11 within a predetermined time interval (as the sleep mode shown in FIG. 7), the controlling and processing circuit 13 reads a second sampling number SIX, of the measurement data of each of the detection cells 111₁-111ₙ at the sampling frequency, wherein the second sampling number SIX, may be 64 or 32, but not limited to. In this embodiment, as the normal mode and the sleep mode have identical frame intervals, in the sleep mode the controlling and processing circuit 13 enters an idle state when the second sampling number of the measurement data has been read. For example, FIG. 5(B) shows that the idle state is entered after the controlling and processing circuit 13 accomplishes reading the measurement data of all of the detection cells 111₁-111ₙ; whereas FIG. 5(C) shows that the idle state is entered every time the controlling and processing circuit 13 accomplishes reading the measurement data of one detection cell 111. As the controlling and processing circuit 13 reads fewer sampling points of the measurement data at the same sampling frequency, the time interval for inputting the drive signal Sd and reading the measurement data Sm is shortened thereby the power consumption is reduced in every frame interval (e.g. the power saved in the idle state in FIGS. 5(B) and 5(C)).

In another embodiment, in the sleep mode the controlling and processing circuit 13 may read the second sampling number SN₂ of the measurement data of only a part of the detection cells 11, e.g. shaded areas filled with oblique lines in FIGS. 3A and 3B, so as to further improve the power saving efficiency. Similarly, in the sleep mode the controlling and processing circuit 13 may respectively read the second sampling number SN₂ of the measurement data of different parts of the detection cells 111 within adjacent frame intervals.

More specifically speaking, in the first embodiment, the controlling and processing circuit 13 may read a lower sampling number of the measurement data of all or a part of the detection cells 111 for confirming the touch information in the sleep mode so that the object of reducing the power consumption is achieved.

FIGS. 5(D) and 5(E) show other operational schematic diagrams of the normal mode (i.e. the partial sleep mode). When the controlling and processing circuit 13 identifies that there is at least one finger in contact with the touch panel 11, the normal mode is entered. However now the controlling and processing circuit 13 reads a first sampling number SN₁ of the measurement data of a first region 111a of the detection cells 111 (e.g. the detection cells 111₃ and 111₄) at the sampling frequency and reads a second sampling number SN₂ of the measurement data of a second region 111b of the detection cells 111 (e.g. the detection cells outside 111₃ and 111₄) at the sampling frequency so as to achieve the object of reducing the power consumption in the normal mode. In this embodiment, the first region 111a may be a predetermined range around a touch point Tc and the second region 111b may be the detection cells 111 outside the first region 111a (e.g. the partial sleep mode shown in FIG. 7). In this embodiment, as the normal mode and the partial sleep mode have identical frame intervals, during reading the measurement data of the second region 111b of the detection cells 111, an idle state is entered when the controlling and processing circuit 13 has read the second sampling number SN₂ of the measurement data. For example, FIG. 5(D) shows that the idle state is entered after the controlling and processing circuit 13 accomplishes reading the measurement data of all of the detection cells 111; whereas FIG. 5(E) shows that the idle state is entered every time the controlling and processing circuit 13 accomplishes reading the measurement data of one detection cell Ill in the second region 111b (e.g. the detection cells outside the detection cells 111₃ and 111₄) but there is no idle state after the controlling and processing circuit 13 accomplishes reading the measurement data of the detection cells 111 in the first region 111a (e.g. the detection cells 111₃ and 111₄).

In another embodiment, the controlling and processing circuit 13 may divide the touch panel 11 into three parts and respectively read a plurality of data points of the measurement data of the detection cells with different sampling numbers; for example in another partial sleep mode shown in FIG. 7, the controlling and processing circuit 13 reads a first sampling number SN₁ of the measurement data of a first region 111a of the detection cells 111, reads a second sampling number SN₂ of the measurement data of a second region 111b of the detection cells 111, and reads a third sampling number SN₃ of the measurement data of a third region 111c of the detection cells 111, wherein the third sampling number SN₃ may be between the first sampling number SN₁ and the second sampling number SN₂, and third region 111c preferably locates between the first region 111a and the second region 111b. In this manner, when the finger moves out of the first region 111a in a next frame interval, the controlling and processing circuit 13 may detect the touch event more instantly, wherein the third region 111c may be selected suitably according to different applications.

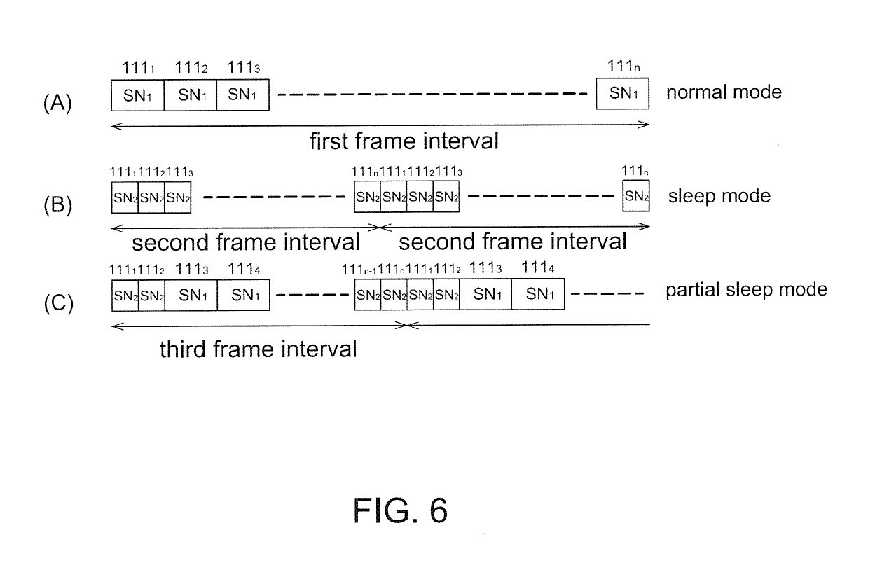

Referring to FIG. 6, it shows an operational schematic diagram of the capacitive touch device according to a second embodiment of the present disclosure. In this embodiment, in a normal mode the controlling and processing circuit 13 may read, within a first frame interval, a first sampling number SN₁ of the measurement data of the detection cells 111 and in a sleep mode the controlling and processing circuit 13 may read, within a second frame interval, a second sampling number SN₂ of the measurement data of the detection cells 111, wherein the second sampling number SN₂ is lower than the first sampling number SN₁ and the second frame interval is shorter than the first frame interval. In this embodiment, the controlling and processing circuit 13 also reads a plurality of data points of the measurement data of each detection cell 111 always at the same sampling frequency and every frame interval does not include an idle state.

FIG. 6(A) shows the operational schematic diagram of the normal mode, and as the normal mode of this embodiment is identical to that of FIG. 5(A), details thereof are not repeated herein.

FIG. 6(B) shows the operational schematic diagram of the sleep mode. When the controlling and processing circuit 13 identifies that there is no finger in contact with the touch panel 11 within a predetermined time interval, the controlling and processing circuit 13 reads a second sampling number SN₂ of the measurement data of each of the detection cells 111₁-111ₙ at the sampling frequency. The difference from the first embodiment is that in the second embodiment as the controlling and processing circuit 13 reads a lower sampling number of the measurement data of the detection cells 111 in the sleep mode, the frame interval is shortened thereby improving the detecting reactivity. For example in FIG. 6(B), after one second frame interval is ended, another second frame interval is directly entered and the second frame interval does not include an idle interval. Accordingly, the reactivity of detecting a first contact for ending the sleep mode is increased under the same power consumption.

In another embodiment, in the sleep mode the controlling and processing circuit 13 may also read the second sampling number SN₂ of the measurement data of only a part of the detection cells 111 as shown by the shaded area in FIGS. 3A and 3B so as to further improve the power saving efficiency. Similarly, in the sleep mode the controlling and processing circuit 13 may read the second sampling number SN₂ of the measurement data of different parts of the detection cells 111 respectively within adjacent second frame intervals.

More specifically speaking, in the second embodiment, the controlling and processing circuit 13 may read a lower sampling number of the measurement data of all or a part of the detection cells 111 for confirming the touch information in the sleep mode thereby shortening the reaction time for ending the sleep mode.

FIG. 6(C) shows another operational schematic diagram of the normal mode (i.e. the partial sleep mode). When the controlling and processing circuit 13 identifies that there is at least one finger in contact with the touch panel 11, the normal mode is entered. However now the controlling and processing circuit 13 reads, within a third frame interval, a first sampling number SN₁ of the measurement data of a first region 111a of the detection cells 111 (e.g. the detection cells 111₃ and 111₄) and reads a second sampling number SN₂ of the measurement data of a second region 111b of the detection cells 111 (e.g. the detection cells outside 111₃ and 111₄) so as to achieve the object of reducing the power consumption in the normal mode, wherein as the controlling and processing circuit 13 reads a lower sampling number of the measurement data of a partial region of the touch panel 11, the third frame interval is shorter than the first frame interval but longer than the second frame interval. Similarly, in this embodiment the first region 111a may be a predetermined range of the detection cells around a touch point Tc and the second region 111b may be all or a part of the detection cells 111 outside the first region 111a. Similarly, in this embodiment the detection cells 111₁-111ₙ may also be divided into more than three parts and the measurement data of difference parts may be respectively read with different sampling numbers. In addition, in the descriptions of the present disclosure, said touch point Tc may have a pointer coordinate obtained according to the scanning of a previous frame interval, wherein said previous frame interval may be operated in the normal mode, the sleep mode or the partial sleep mode referred in the present disclosure. The capacitive touch device 1 preferably includes a storage unit configured to save the pointer coordinate.

It should be mentioned that although every embodiment of the present disclosure is illustrated by using a mutual capacitance touch sensing device, the present disclosure may also be applied to other touch devices such as self capacitance touch sensing device, resistive touch sensing device, optical touch sensing device that have a sensing device covering the main active area of a touch system. For example, in the embedded optical sensing device, the object of reducing the power consumption similar to the embodiment of the present disclosure may be achieved by reducing the exposure time of the photodiode associated with each light sensing unit or by alternatively switching photodiodes of different parts of the light sensing units of the touch panel to detect light.

As mentioned above, the conventional capacitive touch panel reduces the power consumption by decreasing the scanning frequency but has the problem of reduced reaction sensitivity. Therefore, the present disclosure further provides a capacitive touch device (FIGS. 1 and 2) that may reduce the total power consumption of a touch panel in both the sleep mode and the normal mode and the detection time of the occurrence of a first contact will not be delayed.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A capacitive touch device, comprising:
a touch panel comprising a plurality of detection cells arranged in matrix; and
a controlling and processing circuit configured to input a drive signal to the detection cells of the touch panel and read measurement data from the detection cells,
wherein the controlling and processing circuit reads a first sampling number of the measurement data of the detection cells in a normal mode and a second sampling number of the measurement data of the detection cells in a sleep mode; the second sampling number is lower than the first sampling number.

2. The capacitive touch device as claimed in claim 1, wherein the controlling and processing circuit reads the measurement data at a same sampling frequency in the normal mode and the sleep mode; and in the sleep mode an idle state is entered when the controlling and processing circuit accomplishes reading the second sampling number of the measurement data.

3. The capacitive touch device as claimed in claim 1, wherein in the normal mode the controlling and processing circuit reads the first sampling number of the measurement data of a first region of the detection cells and the second sampling number of the measurement data of a second region of the detection cells.

4. The capacitive touch device as claimed in claim 3, wherein the first region is a predetermined range of the detection cells around a touch point.

5. The capacitive touch device as claimed in claim 4, wherein the second region is all or a part of the detection cells outside the first region.

6. The capacitive touch device as claimed in claim 3, wherein during reading the measurement data of the second region of the detection cells, an idle state is entered when the controlling and processing circuit accomplishes reading the second sampling number of the measurement data.

7. The capacitive touch device as claimed in claim 1, wherein in the sleep mode the controlling and processing circuit reads the second sampling number of the measurement data of only a part of the detection cells.

8. The capacitive touch device as claimed in claim 6, wherein the controlling and processing circuit reads the second sampling number of the measurement data of different parts of the detection cells within adjacent frame intervals.

9. The capacitive touch device as claimed in claim 1, wherein the normal mode and the sleep have identical frame intervals.

10. A capacitive touch device, comprising:
a touch panel comprising a plurality of detection cells arranged in matrix; and
a controlling and processing circuit configured to input a drive signal to the detection cells of the touch panel and read measurement data from the detection cells,
wherein the controlling and processing circuit reads, within a first frame interval, a first sampling number of the measurement data of the detection cells in a normal mode and reads, within a second frame interval, a second sampling number of the measurement data of the detection cells in a sleep mode; the second sampling number is lower than the first sampling number and the second frame interval is shorter than the first frame interval.

11. The capacitive touch device as claimed in claim 10, wherein in the normal mode the controlling and processing circuit reads, within a third frame interval, the first sampling number of the measurement data of a first region of the detection cells and the second sampling number of the measurement data of a second region of the detection cells, and the third frame interval is shorter than the first frame interval.

12. The capacitive touch device as claimed in claim 11, wherein the first region is a predetermined range of the detection cells around a touch point.

13. The capacitive touch device as claimed in claim 12, wherein the second region is all or a part of the detection cells outside the first region.

14. The capacitive touch device as claimed in claim 10, wherein in the sleep mode the controlling and processing circuit reads the second sampling number of the measurement data of only a part of the detection cells.

15. The capacitive touch device as claimed in claim 14, wherein the controlling and processing circuit reads the second sampling number of the measurement data of different parts of the detection cells within adjacent frame intervals.

16. A capacitive touch device, comprising:
a touch panel comprising a plurality of detection cells arranged in matrix; and
a controlling and processing circuit configured to input a drive signal to the detection cells of the touch panel and read measurement data from the detection cells,
wherein the controlling and processing circuit reads the measurement data of only a part of the detection cells in a sleep mode.

17. The capacitive touch device as claimed in claim 16, wherein the controlling and processing circuit reads the measurement data of different parts of the detection cells within adjacent frame intervals.

18. The capacitive touch device as claimed in claim 16, wherein the part of the detection cells read by the controlling and processing circuit are a chessboard pattern, non-adjacent rows or non-adjacent columns of the detection cells.

19. The capacitive touch device as claimed in claim 16, wherein in a normal mode the controlling and processing circuit reads the measurement data of all of the detection cells, or reads the measurement data of all detection cells in a first region of the detection cells and the measurement data of a part of detection cells in a second region of the detection cells.

20. The capacitive touch device as claimed in claim 19, wherein the first region is a predetermined range of the detection cells around a touch point.
